(19) United States
(12) Patent Application Publication
(10) Pub. No.: US 2020/0086684 A1
(43) Pub. Date: Mar. 19, 2020

(54) A self-controlled wheel and method to operate it

(71) Applicant: Alexey Fedorovich Khoroshev, Moscow (RU)

(72) Inventor: Alexey Fedorovich Khoroshev, Moscow (RU)

(21) Appl. No.: 16/612,376

(22) PCT Filed: May 8, 2018
(86) PCT No.: PCT/RU2018/000297

§ 371 Date: Nov. 9, 2019

(30) Foreign Application Priority Data
May 11, 2017 (RU) 2017116208

(51) Int. Cl. B60B 19/00; A61G 5/04

(52) U.S. Cl. CPC B60B 19/00; B60K 7/0007; A61G 5/04

(57) ABSTRACT

Relating primarily to the field of transporting are: a device, namely a self-controlled wheel, comprising several parts, admitting of change in the mutual position of individual parts of said self-controlled wheel, which are in contact with a support surface; and a method, namely a method to operate a wheel, comprising several parts, whereby the mutual position of individual parts of that wheel which are in contact with a support surface is changed. The technical outcome is a broader range of technical facilities.

### TECHNICAL FIELD OF INVENTION

The claimed inventions (hereinafter referred to as Inventions) are related to the field where the important task is to have, for the first time ever, a technical facility designed as a Self-controlled Wheel. The Inventions are mostly related to the field of transportation.

### PRIOR ART

Various wheels and methods to operate them are widely known. However, as is clear from the above, there are no facilities similar to the Inventions at present; which is achieved through inventing the first ever technical facility designed as a Self-controlled Wheel, and arriving at a technical outcome consisting in making a Self-controlled Wheel, leading to the claimed new and industrially applicable technical solutions forming an indivisible inventive concept, not expressly ensuing to an expert, from the state of art, consisting in the following items with no analogous art: a Self-controlled wheel, configured to allow a change in the mutual position of individual parts of the wheel which are in contact with a supporting surface, wherein, in a plane of symmetry of the wheel situated in the plane of rotation, at a distance from the centre of rotation of the wheel equal to the radius of a projection of the wheel onto said plane, either an empty space or a rotating surface of the wheel can be situated between the said parts; and a method, namely an operating method for the above wheel, in which the mutual position of individual parts of the wheel which are in contact with a supporting surface are changed, wherein, in a plane of symmetry of the wheel situated in the plane of rotation, at a distance from the centre of rotation of the wheel equal to the radius of a projection of the wheel onto said plane, either an empty space or a rotating surface of the wheel can be situated between the said parts. The set objective, shared between the claimed Inventions, which are interconnected as much as they form one and the same invention concept; complying with the unity concept as a condition that only this application covers the said Inventions; is achieved by the design of the Self-controlled Wheel, resulting from human activity, whose elements form a structural unity and are functionally interconnected, matching the concept of a device as a subject of invention; and matching the concept of a method as an object of invention, the process of action on a material object, namely a wheel, using a material means, namely the Self-controlled wheel design in which the mutual position of individual parts of the wheel which are in contact with a supporting surface are changed, wherein, in a plane of symmetry of the wheel situated in the plane of rotation, at a distance from the centre of rotation of the wheel equal to the radius of a projection of the wheel onto said plane, either an empty space or a rotating surface of the wheel can be situated between the said parts. The set objective, shared between the claimed Inventions, which are interconnected as much as they form one and the same invention concept; complying with the unity concept as a condition that only this application covers the said Inventions; is achieved by the design of the Self-controlled Wheel, resulting from human activity, whose elements form a structural unity and are functionally interconnected, matching the concept of a device as a subject of invention; and matching the concept of a method as an object of invention, the process of action on a material object, namely a wheel, using a material means, namely the Self-controlled wheel design in which the mutual position of individual parts of the wheel which are in contact with a supporting surface are changed, wherein, in a plane of symmetry of the wheel situated in the plane of rotation, at a distance from the centre of rotation of the wheel equal to the radius of a projection of the wheel onto said plane, either an empty space or a rotating surface of the wheel can be situated between the said parts.

### SUBSTANCE OF THE INVENTION

The substance of the Inventions as technical solutions is expressed in the below totality of essential features, which is sufficient to achieve the technical outcome ensured by the above specified Inventions, namely the Self-controlled wheel and the method of wheel operation:

1. Self-controlled wheel, admitting of change in the mutual position of individual parts of the wheel which are in contact with a supporting surface, wherein, in a plane of symmetry of the wheel situated in the plane of rotation, at a distance from the centre of rotation of the wheel equal to the radius of a projection of the wheel onto said plane, either an empty space or a rotating surface of the wheel can be situated between the said parts;

2. An operating method for a wheel, in which the mutual position of individual parts of the wheel which are in contact with a supporting surface are changed, wherein, in a plane of symmetry of the wheel situated in the plane of rotation, at a distance from the centre of rotation of the wheel equal to the radius of a projection of the wheel onto said plane, either an empty space or a rotating surface of the wheel can be situated between the said parts.

This addresses the problem of producing, for the very first time, a technical means referred to as a self-controlled wheel, and achieves the technical result of implementing a self-controlled wheel.

### BRIEF DESCRIPTION OF THE DRAWINGS

FIG. 1 schematically illustrates, by way of an example, a change in the mutual position of individual parts of the Self-controlled wheel, contacting with the support surface;

FIG. 2 schematically illustrates, by way of an example, the position of empty space in the plane of symmetry of the Self-controlled wheel, which is in the plane of rotation, at a distance from the Self-controlled wheel centre of rotation equal to the radius of the projection on that plane;

FIG. 3 schematically illustrates, by way of an example, the position of the rotating surface of the Self-controlled wheel in the plane of symmetry of the Self-controlled wheel, which is in the plane of rotation, at a distance from the Self-controlled wheel centre of rotation equal to the radius of the projection on that plane;

FIG. 4 schematically illustrates, by way of an example, a similar combination and the use of three and more rotors, and other elements forming the respective parts of the Self-controlled wheel.

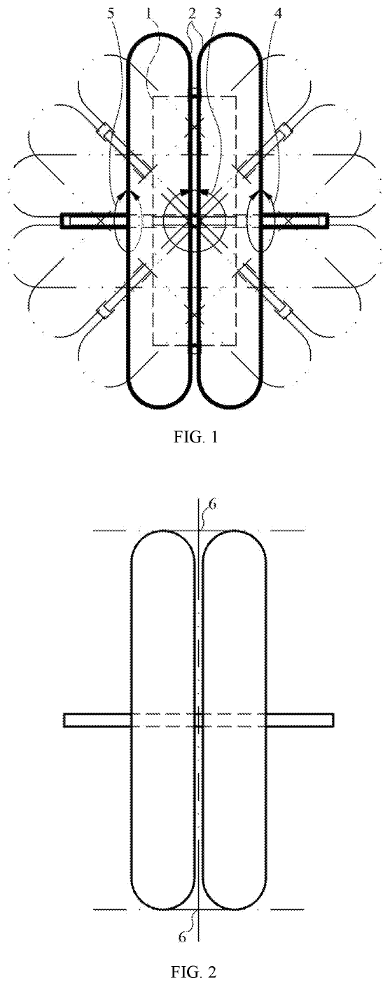

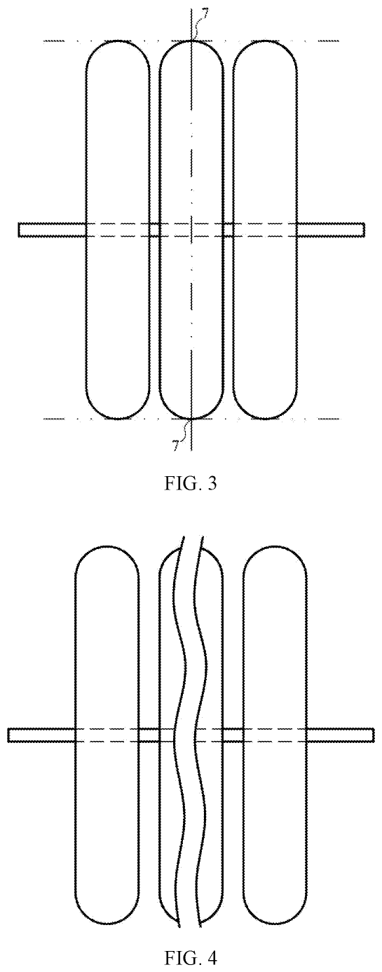

### IMPLEMENTATION OF THE INVENTION

The Inventions will be described in detail below. It should be noted that the Inventions are not confined to the below described Inventions implementation variants. Also, the below described components of the Inventions implementation variants include elements that can easily be proposed by a regular specialist in the respective field of engineering, or elements which essentially are the same as elements that can be proposed by a regular specialist in the respective field of engineering.

The Inventions can be implemented, for example, by manufacturing and operating the Self-controlled Wheel as a brushless electric motor wheel consisting of element 1 fastened on the wheel axis and uniting the stators for two other elements, namely rotors 2, whose external surfaces contacting with the support surface are parts whose unchanging mutual position should not generate a force aiming to change (3) the spatial position of the wheel rotation plane; such a force, however, will inevitably arise if the mutual position of the external surfaces of the two above specified rotors contacting with the support surface changes due to non-uniform —in terms of direction, angular dimension, rotation speed —skewing of each of the said rotors in the course of rotational movement (4; 5) with regard for the wheel axis, whether without full revolution, i.e. at certain different angles, or with full revolutions, i.e. rotation at various speeds, including changing speeds; the arising rotation speed difference between the above rotors will cause a change in the spatial position of the Self-controlled Wheel rotation plane during its rolling motion on the above support surface, while acceleration or deceleration of the change of the above difference in the rotation of the said rotors will cause, respectively, acceleration or deceleration of the above change in the spatial position of the Self-controlled Wheel rotation plane during its rolling motion on the above support surface; meanwhile, the spatial position of the Self-controlled rotation plane can be changed when a skew of each of the said rotors—for a certain different angle only, without full revolution—changes the spatial position of the Self-controlled rotation plane in such a way that the wheel can move from an ability of rolling motion in one direction to an ability of rolling motion in a different direction without any rolling motion on the said support surface because the Self-controlled Wheel, for example, in case of an angular skew of the said rotors for the same value but in an opposite direction, can therefore rotationally move at practically any angle relative to the imaginary axis keeping its spatial position unchanged, running perpendicular to the wheel rotation plane and through that axis from the central point of the zone of wheel contact with the said support surface.

Inventions can be implemented, for example, by means of a similar combination and use of three or more rotors and other elements making independently controlled parts of the Self-controlled Wheel (FIG. 4), wherein, in a plane of symmetry of the wheel situated in the plane of rotation, at a distance from the centre of rotation of the wheel equal to the radius of a projection of the wheel onto said plane (6; 7), either an empty space (6) or a rotating surface of the wheel (7) can be situated between the said parts which, too, can help to achieve the ability to change the mutual position of individual parts of said Self-controlled Wheel, thus ensuring implementation of the Self-controlled Wheel as well.

If necessary, the description of the above-said variant of claimed Inventions implementation should be viewed as a description of at least the best mode of the applicant's suggested variants of implementation of the claimed Inventions.

To conclude, it should also be noted that, while the Inventions were described with reference to potential variants of their implementation, one should be aware that the Inventions are not limited to the potential implementation variants, material, or designs described above, but they cover all and any variants within the scope of the claimed Inventions. It should also be understood that the Inventions are designed to include various modifications, equivalent positions, and any other variants of using the Inventions. Besides, one should also realize that, while various elements of the potential implementation variants are described in various combinations and configurations which are potential or serve as an example, other combinations and configurations including a bigger or smaller number of elements or just one element can also conform and comply with the substance and scope of the Inventions.

### INDUSTRIAL APPLICABILITY

Evident from the description and character of the invention.

1. A self-controlled wheel, comprising several parts, admitting of change in the mutual position of individual parts of said self-controlled wheel, which are in contact with a support surface.

2. A method to operate a wheel, comprising several parts, whereby the mutual position of individual parts of that wheel, which are in contact with a support surface, is changed.
